(19) United States
(12) Patent Application Publication
(10) Pub. No.: US 2023/0121366 A1
(43) Pub. Date: Apr. 20, 2023

(54) AI BASED SYSTEM FOR WARNING AND MANAGING OPERATIONS OF VEHICLES AT HIGHER SPEEDS

(71) Applicants: Adel Sulaiman, Najran (SA); Abdullah Alghamdi, Najran (SA); Hani Alshahrani, Najran (SA); Sultan Alyami, Najran (SA); Mana Saleh Al Reshan, Najran (SA); Yousef Asiri, Najran (SA); Mohammad Alsulami, Najran (SA); Asadullah Shaikh, Najran (SA); Samar M. Alqhtani, Najran (SA); Mohammad Tabrez Quasim, Bisha (SA)

(72) Inventors: Adel Sulaiman, Najran (SA); Abdullah Alghamdi, Najran (SA); Hani Alshahrani, Najran (SA); Sultan Alyami, Najran (SA); Mana Saleh Al Reshan, Najran (SA); Yousef Asiri, Najran (SA); Mohammad Alsulami, Najran (SA); Asadullah Shaikh, Najran (SA); Samar M. Alqhtani, Najran (SA); Mohammad Tabrez Quasim, Bisha (SA)

(21) Appl. No.: 18/081,836

(22) Filed: Dec. 15, 2022

(51) Int. Cl. B60W 50/14; B60W 40/08; B60W 40/04; B60W 30/095; G06V 20/59; G06V 40/18

(52) U.S. Cl. CPC B60W 50/14; B60W 40/08; B60W 40/04; B60W 30/0956; G06V 20/597; G06V 40/18; B60W 2050/146; B60W 2040/0818; B60W 2420/42; B60W 2540/225; B60W 2540/229

(57) ABSTRACT

An integrated motor vehicle dangerous driving warning and control system comprising at least one specialized computer machine including electronic AI decision making capability further comprising one or more vehicle sensors for monitoring the vehicle and for monitoring activities of the driver including activities related to the use of cellular phones or other wireless communication devices and further comprising electronic communications transceiver assemblies for communications with external sensor networks for monitoring dangerous driving situations, weather and climatic conditions, pedestrian congestion and motor vehicle traffic congestion conditions to derive warning and/or control signals for warning the driver of dangerous driving situations and/or for controlling the vehicle driver use of a cellular telephone and/or other wireless communication devices.

### FIELD OF THE INVENTION

Various embodiments of the present invention generally relate to a vehicle control system. More specifically, the invention relates to an Artificial Intelligence (AI) system for warning and managing operations of vehicles at higher speeds.

### BACKGROUND OF THE INVENTION

Over the last few years many car manufacturers have invested in the research for automotive advanced driver assistance systems (ADAS) for safety and better driving performances.

For this reason, the ADASs are one of the most quickly growing segments of the automotive industry. The safety features of these systems are designed to avoid collisions and accidents, offering technologies that warn drivers of potential problems, or to avoid collisions through the implementation of safety measures and taking over control of the motor-vehicles. The adaptive features can automate the lighting, provide an adaptive cruise control, automate braking, incorporate GPS signals/traffic, connect smartphones, warn drivers of other vehicles of possible dangers, keep drivers in the right lane or show blind spots.

The ADAS technology is based on vision/camera systems, sensory systems, automotive data networks, Vehicle-to-Vehicle (V2V) communication systems and Vehicle-to-Infrastructure (V2I) communication systems.

The next generation advanced driver assistance systems will exploit wireless connections to a greater extent, in order to offer an added value to the V2V and V2I communication.

Advanced driver assistance systems are destined to become much more popular in the next ten years than they are nowadays, as they will help reach the goals set by the European Union for the 2011-2020 decade in terms of reduction of road accidents.

Indeed, according to the studies carried out by the Accident Research of the German Association of Insurers (GDV), lane assist systems alone are capable of preventing up to 15% of road accidents, whereas intersection assistance can avoid up to 35% of road accidents.

Technological developments, such as the integration of radars and cameras, and the merging of sensors of multiple applications are likely to cause a reduction of costs, which could lead to a more significant penetration of advanced driver assistance systems in the compact vehicle market within 2018.

Existing prior art discloses a motor vehicle alert system based on vehicle dynamics input and comprising a communication module positioned in a host vehicle to receive and send vehicle data in a vehicle mobility data format. A list generator in communication with the communication module generates the data of the motor-vehicle as specific vehicle identification data in a track list to distinguish a sensed motor-vehicle and at least another motor-vehicle positioned proximate to the Host Motor-Vehicle. A tracker module in communication with the list generator periodically updates the vehicle data for the sensed vehicle and the other vehicle. A transient condition data device generates data identifying when a transient condition of the sensed vehicle is present. A message standard conformance module receives the data identifying the transient condition and forwards the data identifying the transient condition to the communication module for transmission to at least another vehicle proximate to the host vehicle.

In addition, existing prior art discloses a vehicle awareness system for monitoring remote vehicles relative to a host vehicle. The vehicle awareness system includes at least one object sensing device and a vehicle-to-vehicle V2V communication device. A data collection module is provided for obtaining a sensor object data map and V2V object data map. Furthermore, there is provided a fusion module, which merges the sensor object data map and V2V object data map for generating a cumulative object data map. Finally, a tracking module estimates the relative position of the remote vehicles to the host vehicle.

Further, the existing art discloses a system for generating risk indicators, which involves determining a route of a vehicle and routes of external objects. The vehicle route is determined using vehicle route data including a vehicle location and a vehicle destination. The external object routes are determined using external object route data including external object locations and external object destinations. Based on a comparison between the vehicle route data and the external object route data, external object routes that satisfy a proximity criterion are determined. Risk data for the vehicle are generated based on a state of the vehicle and on states of the external objects corresponding to the external object routes that satisfy the proximity criterion. In response to determining that the risk data satisfies a risk criterion, at least one risk indicator is generated.

Therefore, there exists a need for an Artificial Intelligence (AI) expert system for warning and control operations of vehicles at higher speeds.

### SUMMARY OF THE INVENTION

Various embodiments of systems and methods for improved warning of drivers of dangerous driving situations and for control of the use of cellular telephones and/or other wireless telecommunication devices by drivers of a moving vehicle are disclosed.

In an embodiment, electronic specifically programmed motor vehicle device control system and methods are disclosed, with at least one specialized electronic communication computer machine including electronic artificial intelligence expert system decision making capability using one or more motor vehicle electronic sensors capable of monitoring activities of the motor vehicle and the driver and/or passengers including activities related to the use of cellular telephones and/or other wireless communication devices and further comprising electronic communications transceiver assemblies for communications with external sensor networks to obtain information on weather conditions, roadway conditions, pedestrian traffic and/or traffic congestion conditions and other dangerous situations wherein the electronic specifically programmed motor vehicle device control system and methods make use of artificial intelligence expert system decision making capability based on the electronic sensor inputs to derive warning and control signals for warning the driver of dangerous driving situations and/or for controlling the motor vehicle driver use of the cellular telephone and/or other wireless communication devices.

One or more shortcomings of the prior art are overcome, and additional advantages are provided through the invention. Additional features are realized through the techniques of the invention. Other embodiments and aspects of the disclosure are described in detail herein and are considered a part of the invention.

### BRIEF DESCRIPTION OF THE FIGURES

The drawings and detailed descriptions are not intended to limit the invention to the particular form disclosed, but on the contrary, the intention is to cover all modifications, equivalents and alternatives falling within the spirit and scope of the present invention as defined by the appended claims.

FIG. 1 illustrates environment of an AI based expert system in accordance with an embodiment of the invention.

FIG. 2 illustrates is a diagram that illustrates a AI module and its components in accordance with an embodiment of the invention.

FIG. 3 illustrates a block diagram form a device control unit with capabilities in accordance with an embodiment of the invention.

FIG. 4 illustrates an example placement of near field communication sensors in a vehicle interior in accordance with an embodiment of the invention.

Skilled artisans will appreciate that elements in the figures are illustrated for simplicity and clarity and have not necessarily been drawn to scale. For example, the dimensions of some of the elements in the figures maybe exaggerated relative to other elements to help understanding of embodiments of the present invention.

### DETAILED DESCRIPTION OF THE INVENTION

Before describing in detail embodiments that are in accordance with the present invention, it should be observed that the embodiments reside primarily in combination or method steps and components related to an Artificial Intelligence (AI) expert system for warning and control operations of vehicles at higher speeds. Accordingly, components and method steps have been represented where appropriate by conventional symbols in the drawings, showing only those specific details that are persistent to understanding the embodiments of the present invention so as not to observe the disclosure with details that will be readily apparent to those of ordinarily skill in art having the benefit of the description herein.

In this document, relational terms such as first and second, top and bottom, and the likely may be used solely to distinguish one entity or action from another entity or action without necessarily requiring or implying any relationship or order between such entities or actions. The terms “comprises”, “comprising”, or any other variation thereof are intended to cover a nonexclusive inclusion, such that a process, method, article, or apparatus that comprises a list of elements does not include only those elements but may include other elements no expressly listed or inherent to such process, method, article, or apparatus. An element proceeded by “comprises . . . a” does not, without more constraints, preclude the existence of additional identical elements in the process, method, article, or apparatus that comprises the element.

In an aspect of some embodiments of the invention, the electronic specifically programmed motor vehicle device control systems and methods electronic sensors comprise near field communication sensors.

In a further aspect of some embodiments of the invention, the electronic specifically programmed motor vehicle device control systems and methods electronic sensors comprise noise reduction beamforming microphone arrays.

In a further aspect of some embodiments of the invention, the electronic specifically programmed motor vehicle device control systems and methods electronic sensors comprise interference reduction directional RF antennas.

Generally speaking, pursuant to various embodiments, the invention provides an Artificial Intelligence (AI) expert system for warning and control operations of vehicles at higher speeds.

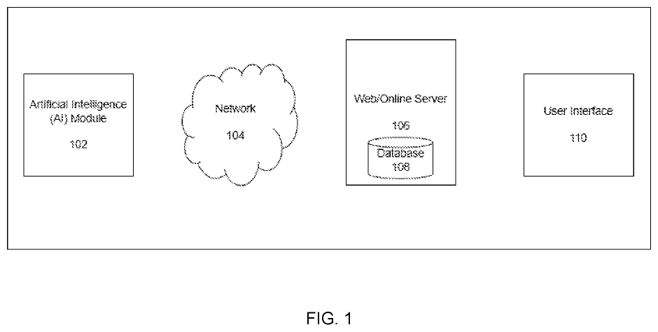

FIG. 1 is a diagram that illustrates environment 100 of an AI based expert system in accordance with an embodiment of the invention. Referring to FIG. 1, the environment 100 comprises an Artificial Intelligence (AI) Module 102, a network 104, a web server 106 comprising database 108, and a user interface 110.

The AI module 102 may take the form of a desktop computer, laptop computer, tablet computer, smartphone, smartwatch or other wearable computer, mainframe computer, quantum computer, or any other form of computer or mobile device now known or to be developed in the future that is capable of running a program, accessing a network or querying a database.

As is well understood in the art of computer technology, and depending upon the technology, the performance of a computer-implemented method may be distributed among multiple computers and/or between multiple locations. One the other hand, in this presentation of the computing environment 100, a detailed discussion is focused on a single computer, specifically the AI module 102, to keep the presentation as simple as possible. The AI module 102 may be located in a cloud, even though it is not shown in the present invention.

In accordance with an embodiment, the network 104 in any network or combination of networks of devices that communicate with one another. For example, the network 104 may be anyone or any combination of a local area network (LAN), wide area network (WAN), home area network (HAN), backbone networks (BBN), peer-to-peer networks (P2P), telephone network, wireless network, point-to-point network, star network, token ring network, single tenant or multi-tenant cloud computing networks, hub networks, and public switched telephone networks (PSTN), or other appropriate configuration known by person skilled in the art to interconnect the devices. The user interface 110 may communicate via the network 104 using TCP/IP and user other common internet protocols to communicate at a higher network level, such as HTTP, FTP, AFS, WAP, etc.

In some embodiments, the network 104 of the computing environment 100 may utilize clustered computing and components acting as a single pool of seamless resources when accessed through the network 104 by one or more computing systems. For example, such embodiments can be used in a data center, cloud computing network, storage area network (SAN), and network-attached storage (NAS) applications.

The web server 106 maybe a laptop computer, netbook computer, personal computer (PC), a desktop computer, or any programmable electronic device or any network of programmable electronic devices capable of hosting and running a monitoring program and a database and communicating with the user interface 110 via the network 104, in accordance with embodiments of the present invention. As will be discussed with reference to FIG. 1, the web server 106 may include internal components and external components, respectively. The web server 106 may also operate in a cloud computing service model, such as software as a service (SaaS), Platform as a service (PaaS), infrastructure as a service (IaaS). The web server 106 may also be located in a cloud computing deployment model, such as a private cloud, community cloud, public cloud, or hybrid cloud.

The database 108 may be a digital repository capable of data storage and data retrieval. The database 108 can be present in the web server 106 and/or any other location in the network 104. The database 108 may include a knowledge corpus.

The user interface 110 is any computer system used and controlled by an end user and may take any of the forms discussed above in connection with the computing environment 100. The interface 110 typically receives helpful and useful data from the operations in the computing environment 100. For example, in a hypothetical case where the AI module 102 is designed to provide a recommendation to an end user, this recommendation would typically be communicated via network 104 of the computing environment 100 through a wide area network (WAN). In this way, the user interface 110 maybe a client device, such as thin client, heavy client, mainframe computer, desktop computer, and so on.

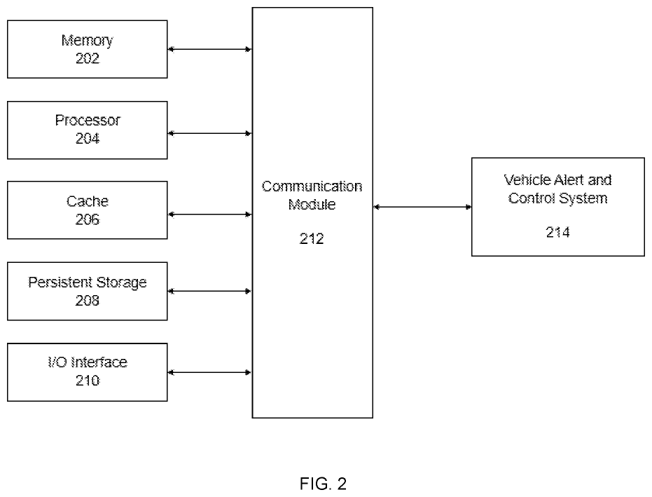

FIG. 2 is a diagram that illustrates the AI module 102 for warning and control operations of vehicles at higher speeds in accordance with an embodiment of the invention. Referring to FIG. 2, the system 200 comprises memory 202, a processor 204, a cache 206, a persistent storage 208, I/O interfaces 210, a communication module 212, an image reception module 214, a conversion module 216, a base model selection module 218, a parameter estimation module 220, a machine learning (ML) network module 222, a dataset training module 224, and a 3D model rendering engine 226.

The memory 202 may comprise suitable logic and/or interfaces that may be configured to store instructions (for example, the computer-readable program code) that can implement various aspects of the present invention. In an embodiment, the memory 202 includes random access memory (RAM). In general, the memory 202 can include any suitable volatile or non-volatile computer-readable storage media.

The processor 204 may comprise suitable logic, interfaces, and/or code that may be configured to execute the instructions stored in the memory 202 to implement various functionalities of the system 200 in accordance with various aspects of the present invention. The processor 204 may be further configured to communicate with multiple modules of the system Via the communication module 212.

The cache 206 is a memory that is typically used for data or code that should be available for rapid access by the threads or cores running on the processor 204. Cache memories are usually organized into multiple levels depending upon relative proximity to the processing circuitry. Alternatively, some, or all, of the cache for the processor set may be located “off-chip”.

Computer readable program instructions are typically loaded onto the system 200 to cause a series of operational steps to be performed by the processor 204 and thereby effect a computer-implemented method, such that the instructions thus executed will instantiate the methods specified in flowcharts and/or narrative description of computer-implemented methods included in this document (collectively referred to as “the inventive methods”). These computer-readable program instructions are stored in various types of computer-readable storage media, such as the cache 206 and the other storage media discussed below. The program instructions, and associated data, are accessed by the processor 204 to control and direct the performance of the inventive methods.

The Persistent storage 208 is any form of non-volatile storage for computers that is now known or to be developed in the future. The non-volatility of this storage means that the stored data is maintained regardless of whether power is being supplied to the system 200 and/or directly to the persistent storage 208. The Persistent storage 208 mat be a read only memory (ROM). Still, typically at least a portion of the persistent storage allows writing of data, deletion of data, and re-writing of data. Some familiar forms of persistent storage include magnetic disks and solid-state storage devices. The media used by persistent storage 208 may also be removable. For example, a removable hard drive may be used for persistent storage 208. Other examples include optical and magnetic disks, thumb drives, and smart cards inserted into a drive for transfer onto another computer-readable storage medium that is also part of persistent storage 208.

The I/O interfaces 210 allow for input and output of data with other devices that may be connected to each computer system. For example, the I/O interface(s) 210 may provide a connection to an external device(s) such as a keyboard, a keypad, a touch screen, and/or some other suitable input device. External device(s) can also include portable computer-readable storage media, such as, for example, thumb drives, portable optical or magnetic disks, and memory cards. Program instructions and data (e.g., software and data) used to practice embodiments of the present invention can be stored on such portable computer-readable storage media and loaded onto the persistent storage 208 via the I/O interface(s) 210.

The communication module 212 comprises suitable logic, interfaces, and/or code that may be configures to transmit data between modules, engines, databases, memories, and other components of the vehicle alert control system 214.

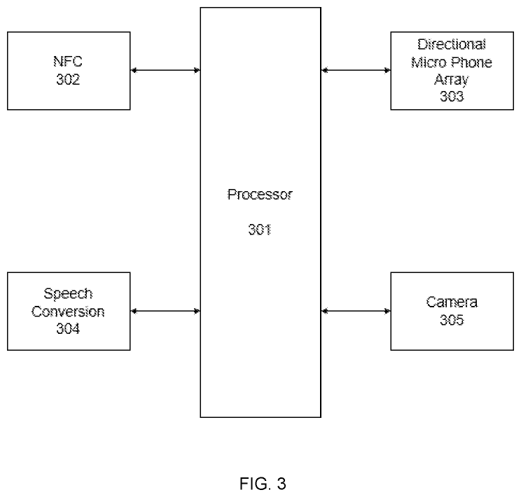

FIG. 3 depicts, without limitation, a block diagram of possible elements of an exemplary device control unit (300) corresponding to device control unit (102) of FIG. 1. The device control unit (300) of FIG. 3 depicts a comprehensive collection of possible capabilities of the device control unit (102) of FIG. 1. It is to be understood that the device control unit (102) of FIG. 1 and as described elsewhere in this specification or in different embodiments of this invention may include all or a selected subset of the total capability of the device control unit (300) of FIG. 3.

The processor (301) may be of any suitable configuration known to those of skill in the art. For example, the processor (301) may be a computer, microprocessor, a DSP (digital signal processor), or other control circuitry suitable for this application. In addition, the processor (301) may be configured using a combination of these technologies.

As shown in FIG. 3, the device control unit may include multiple interconnected capabilities that may be attached to or designed as an integral part of the hardware or software of the processor (301).

As indicated in FIG. 3, the device control unit (300) may include hands-free unit (315) permitting operation of a telecommunications device or cellular telephone in a hands-free mode. Such units may connect to a telecommunications device or cellular telephone using, for example conventional Bluetooth or Bluetooth Low Energy (BLE) (310), Wi-Fi (311) or other radio frequency data transceiver (309) communication links. The hands-free unit (315) permits answering, placing and carrying on voice or text communications via an external cellular telephone network using voice commands only without requiring the driver to hand-manipulate or operate telecommunications or cellular telephone equipment while driving.

As indicated in FIG. 3, the device control unit may also include connections to near field communication (NFC) sensors (302) to assist in determination that the driver of the motor vehicle is using a wireless communication device such as a cellular telephone. As explained further below NFC sensors may be used to detect the use of a cellular telephone in close proximity to that sensor, typically within 10 cm to 20 cm distance. Such sensors operate through magnetic induction and are being implemented today in a variety of devices to detect the presence of items of interest and to exchange information with such items for the particular purposes being served.

As also indicated in FIG. 3, the device control unit (300) may include one or more directional, beamforming microphone arrays (303). Such directional, beamforming microphone arrays are useful in isolating and capturing audio voice signals from individual speakers in the presence of interfering signals from other speakers and other environmental noise signals. For example, in the environment depicted in FIG. 1, environmental noise signals may include audio signals generated from other sources including other passengers, radio, automotive engine and vehicle operation and external noises such as generated by traffic or wind outside of the vehicle or other road noises. Directional beamforming microphone arrays are particularly useful in isolating speech signals of a desired speaker to the exclusion of other noise signals in the environment of the speaker.

As also shown in FIG. 3, the device control unit (300) may include a speech-to-text conversion capability (304). In some embodiments of this invention the speech-to-text conversion capability (304) may be used to convert speech signals received from the directional microphone arrays (303) to text form, as well as for conversion of speech signals received by the device control unit (300) from the telecommunication device or cellular telephone being used by the vehicle driver to for texting. The device control unit (300) may compare the converted text form of speech signals received from the directional microphone arrays with those received from the telecommunication device cellular telephone as part of the verification that the driver is indeed using those communication devices while driving as explained further below. Also, in some embodiments, the speech/text conversion capability (304) may be used to convert text information or messages to speech enabling communicating with the driver of the motor vehicle or others in the motor vehicle in an audible, recognizable speech format. This capability may be important in some embodiments for system control and providing audible instructions or warnings to the driver and/or other occupants of the motor vehicle, informing them of dangerous situations or activities.

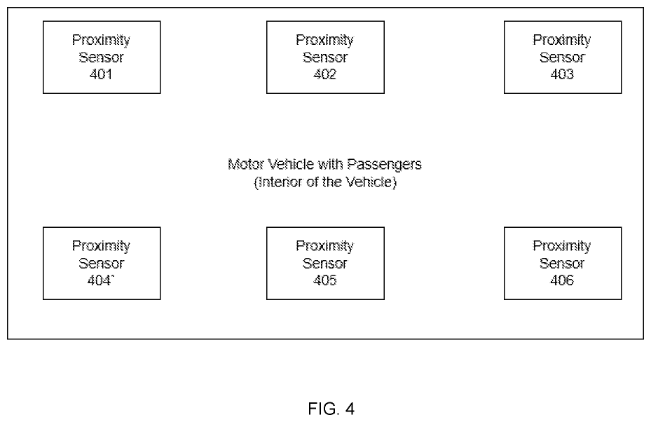

FIG. 4 depicts, without limitation, the possible location of proximity sensors such as Near Field Communication (NFC) proximity sensors to detect particular electronic devices such as cellular telephone, tablet computers or other electronic communication devices being used by particular passengers in particular locations in the motor vehicle (400). For example, proximity sensor (401) may be located at the rear top of the driver's seat in close proximity to the driver's head to detect possible use of such electronic devices by the driver.

Similarly, proximity sensor (402) may be placed at the top of the front passenger seat to monitor the use of such electrical devices by that passenger. Other possible locations of such sensors include the motor vehicle interior roof or head-liner near the head of the driver and/or passenger illustrated by proximity sensors (403) and (404) to detect the use of such electronic devices. Texting or other manual use of handheld devices such as cellular telephones and/or laptop computers are generally carried out in or near the lap of the driver or passengers. The location of proximity sensors, such as NFC sensors, may include the door side panel proximity sensor (405) or proximity sensor (406) located in the steering wheel to detect operation of such electronic devices located in the general lap area of the passenger or driver. Similar sensor locations, not shown, may be used to monitor activities of passengers in other seats of motor vehicles.

Although the embodiments above have been described in considerable detail, numerous variations and modifications will become apparent to those skilled in the art once the above disclosure is fully appreciated. For example, embodiments with more or fewer variables to be analyzed as described above are possible. Variations of the artificial intelligence expert system analysis may be used.

Embodiments for the device control unit as described above, for example, in FIGS. 2 and 3 may be integrated in various degrees with other motor vehicle telematics or system control processors and sensor systems. In some embodiments the device control unit of FIGS. 2 and 3 may include only a subset of the capabilities indicated in FIG. 3. In some embodiments, the device control unit of FIGS. 2 and 3 may include additional capabilities not shown herein. While the above disclosure is based on a standard automobile vehicle environment, the same teachings set forth herein may be applied to other vehicles such as trucks, buses, military vehicles, emergency vehicles such as fire trucks and ambulance and the like. It is intended that the following claims be interpreted to embrace all such variations and modifications.

Compared to the prior art solutions based on physical measurements carried out by means of on-board sensors, such as, for example, light and microwave detection and ranging, sonar, lidar, cameras, etc., the ADAS of the invention offers better performances and operating conditions because:

it operates also with motor-vehicles outside the field of vision (when the communication does not take place in the field of vision because it is blocked by obstacles),

it operates at 360 degrees around the transmitting and receiving antenna (according to the requirements defined by the SAE standard),

it operates in a more extended range of distances,

it is more flexible than traditional ADAS sensors because it provides more information than a physical detection (which only provides information on the kinematics of the motor-vehicles), also including information on the driving intentions (for instance, the turning by means of activated direction indicators and steering angle),

when it is applied to different types of motor-vehicles and road users, for example pedestrians, it allows for a classification of the type of object detected based on the information sent by the object itself (car, motorcycle, ambulance, pedestrians, etc.), and it can be further extended with infrastructure-based information (V2I). For example, information on the state of the traffic light phase could be outputted on the CAN bus of the Host Motor-Vehicle as virtual object and the relevant attributes could be the time to change, the current phase and the next phase of the traffic light.

Furthermore, compared to a prior art V2X communication system which integrates V2V applications, the ADAS of the invention features the main advantage of being flexible and of facilitating the development of the system in an industrial environment. Indeed, depending on the development needs, the ADAS of the present invention can be easily customized so as to provide information aimed at developing standalone basic application, integrated advanced applications and new applications.

Standalone signaling applications are functionalities providing warnings exclusively based on V2V communications in all basic scenarios, for example in SAE J2945 for the six applications EEBL, FCW, LCW, IMA, LTA, CLW. These applications are affected by technological limits: complete dependence on the GNSS, decrease of performances in crowded city environments (caused by the urban-cannoning phenomenon because of GNSS and RF problems—multipath GNSS, fading RF).

Integrated applications improve or extend the functionalities of the aforesaid applications, e.g. EBL, FCW, LCW, IMA, LTA, CLW, as part of the existing functionalities, through the melting of output data of the V2V communication system with the output of other sensors. In this case there can be both the signaling and the activation, depending on the functionality. For example:

the virtual objects enabling the SAE J2945 applications of EEBL, CLW and FCW can be used in an existing front collision warning functionality, thus also allowing for the detection of further motor-vehicles relative to the current system and for the recognition of events such as, for example, pre-loading of the ESC or of similar systems of the motor-vehicle,

the virtual objects enabling the SAE J2945 application of LCW can be used in an existing lane change functionality, since they improve the field of vision and provide redundancy relative to the RADAR, as independent source of information (useful for self-driving),

the virtual objects enabling the SAE J2945 application of IMA could be useful for an existing intersection collision avoidance (ICA) functionality, as it improves the field of vision, thus allowing for different geometries of road intersections relative to the standard 90-degree standard intersection, and the line of vision, especially taking into account lateral obstacles of the field of vision caused by buildings and parked cars, and

the virtual objects enabling the SAE J2945 application of LTA could improve the existing left turn assistance functionality, since it is capable of recognizing the left turn scenario regardless of the other sensors, such as the camera. In particular, it can recognize the lane based on switched trajectories and can ensure good performances even in the absence of lane signs.

Furthermore, the invention can easily be extended and transferred to other communication protocols which allow for the development of V2X applications and services, such as the emergent cellular technologies Cellular-V2X (C-V2X) and the future 5G, through the interfaces referred to as “PC5” and “Uu” in the state of the art, which are dedicated to the local vehicle-to vehicle and vehicle-to infrastructure communication, respectively.

1. An Artificial Intelligence (AI) expert system for warning and control operations of vehicles at higher speeds, comprising:
AI decision making utilizing specifically programmed computing system;
integration of AI vehicle danger driving warning and control method with motor vehicle information processing and display system operations;
monitoring the motor vehicle driver with one or more sensor(s) and providing sensor input to specifically programmed, communication computer system; and
providing an expert system derived combined composite degree of danger warning index based on multiple selected motor vehicle driver and motor vehicle driving condition sensor inputs.

2. The AI expert system for warning and control operations of vehicles at higher speeds, as claimed in claim 1, wherein monitoring of vehicle driver comprises monitoring driver alertness to vehicle driving.

3. The AI expert system for warning and control operations of vehicles at higher speeds, as claimed in claim 1, further configured to filter the list of Nearby Motor-Vehicles (RMV) based on times-to-collision (TTC) for the Host Motor-Vehicle (HMV) to collide with the Nearby Motor-Vehicles (RMV), and on relevant event flags.

4. The AI expert system for warning and control operations of vehicles at higher speeds, as claimed in claim 1, wherein monitoring of driver alert to vehicle driving includes checking eye movement with a camera.
